(19) United States
(12) Patent Application Publication
(10) Pub. No.: US 2024/0316911 A1
(43) Pub. Date: Sep. 26, 2024

(54) High Strength Bonded Film And A Method Of Making It

(71) Applicant: API Industries, Inc., Orangeburg, NY (US)

(72) Inventor: David Anderson, Seven Lakes, NC (US)

(21) Appl. No.: 18/612,821

(22) Filed: Mar. 21, 2024

Related U.S. Application Data
(60) Provisional application No. 63/454,261, filed on Mar. 23, 2023.

(51) Int. Cl. B32B 27/08; B29C 48/00; B29C 48/08; B32B 7/02; B32B 7/12

(52) U.S. Cl. CPC B32B 27/08; B32B 7/02; B32B 7/12; B29C 48/0018; B29C 48/0019; B29C 48/08; B32B 2307/30; B32B 2307/54; B32B 2307/7376

(57) ABSTRACT

A high strength multilayer film includes a film-web having an odd number of layers, the film-web includes a bonding layer located between two core-strength layers, wherein the film-web is formed from a concentric-multilayer polymer structure in which an inner layer of the concentric-multilayer polymer structure includes a bonding material. For the bonding layer of thickness 2*Z and the two strength layers of thickness Y each, the film-web has a tensile strength at yield that is greater than of a film-web that (i) lacks the bonding layer and (ii) includes a single core-strength layer of thickness 2*(Y+Z).

### CROSS-REFERENCE TO RELATED APPLICATIONS

This application claims the benefit of U.S. provisional application No. 63/454,261 filed Mar. 23, 2023, which is incorporated herein in its entirety.

### BACKGROUND OF THE INVENTION

The present invention involves a multi-layer high strength bonded film. The film can be used in many commercial applications, including manufacture of trash bags.

Plastic film, especially the kind used in trash bags, must have sufficient tensile strength and must be air and moisture impenetrable. Prior art films used for making trash bags typically either include a single film layer that combines both strength and sealing properties, or they include three film layers, two sealing layers sandwiching the middle layer that provides tensile strength (core-strength layer).

Plastic films are typically made using extrusion processes. As known in the art, resin molecules are long-chain molecules. To increase tensile strength of a resin layer, the long axis of the molecules should be oriented in the direction of the tensile force. Thus, the more long-chain molecules in the resin layer are oriented along a tensile (stretching) direction, the greater the layer's tensile strength. Resin extrusion involves melting resin pellets, which causes the long-chain molecules to orient themselves randomly, and then forcing the melted resin to flow through a die. Dies include resin-flow channels that taper and then extend to give the molten resin a specific shape at the channels' outputs. In other words, molten resin flows through a die channel having an input opening of width (thickness) S1 and an output opening of a smaller width (thickness) S2. The S1/S2 ratio is called a draw-down ratio. Although long-chain molecules in a molten resin at the die's input are oriented randomly, as the molecules flow through the narrow channel they start aligning along the channel's (flow) direction. Importantly, the greater the draw-down ratio, i.e., the smaller the channel's width, the greater the resulting molecular alignment.

Prior art single-layer films are typically fabricated using a single extruder machine. At the same time, prior art three-layer films typically use two extruder machines, one for co-extruding a core-strength layer and the other for co-extruding the sealing layer. A die, located downstream from the extruders, is used to sandwich the core-strength layer between the two sealing layers. In either case, in the prior art films, mostly all of the tensile strength is provided by a single layer of strength providing material.

### SUMMARY OF THE INVENTION

In contrast to conventional films, for the same overall thickness (gauge) of the strength providing material, the invented high strength film includes two thin layers of core-strength material that are bonded together. The resulting tensile strength of the two bonded core-strength layers combined is greater than a single layer of strength-providing material in the prior art films. For example, the two bonded core-strength layers, each of thickness Y, of the present invention combine to provide greater tensile strength than a single core-strength layer of thickness 2*Y in the prior art. As explained in further detail below, the reason for this is molecular alignment in the core-strength layers of the invented film.

In one embodiment of the invention, the invented film includes five layers: two high strength layers, a bonding layer sandwiched between the two high strength layers, and two sealant layers. Each sealant layer is located on the outside of its corresponding high strength layer.

In one embodiment, the invented multilayer film comprises a film-web having an odd number of layers that includes a bonding layer located between two strength layers, wherein the film-web is formed from a concentric-multilayer polymer structure in which an inner layer of the concentric-multilayer polymer structure includes a bonding material. For the bonding layer of thickness 2*Z and the two strength layers of thickness Y each, the film-web has a tensile strength at yield that is at least 20% greater than of a film-web that (i) lacks the bonding layer and (ii) includes a single strength layer of thickness 2*(Y+Z).

In one embodiment, the invented multilayer film-web further includes two sealant layers of thickness X each, so that the two strength layers are located between the two sealant layers.

In one embodiment, a multilayer film comprises (a) a film-web having an odd number of resin lavers that includes a bonding layer that is located between the two strength layers, wherein the film-web is formed from a set of concentric polymer layers having a tubular profile in which an inner polymer layer includes a bonding material.

In one embodiment, the tensile strength of the invented multilayer film-web is further enhanced by stretching, either by hot-stretching, cold-stretching or both. During hot-stretching, the film-web may be stretched by at least 1%. During cold-stretching, the film-web may also be stretched by at least 1%.

In one embodiment, the method of producing a multilayer film includes the steps of: (i) using a die to output a flowing molten concentric-multilayer polymer structure in which an inner layer of the concentric-multilayer polymer structure includes a bonding resin and at least one non-inner layer of the concentric-multilayer polymer structure includes a strengthening resin, (ii) expanding a radius of the molten concentric-multilayer polymer structure; (ii) cooling the expanded concentric-multilayer polymer structure to form a non-molten expanded concentric-multilayer polymer structure; and flattening the non-molten expanded concentric multilayer polymer structure to form a film-web having an odd number of layers that includes a bonding layer located between two strength layers.

In one embodiment of the method, the flattening step includes using a collapsing frame.

In one embodiment, the flattening step further includes using a pair of nip rollers.

In one embodiment, the method further includes hot-stretching the film-web, cold stretching the film web, or both.

In one embodiment, the method, further includes the step of allowing the film-web to relax.

### BRIEF DESCRIPTION OF THE DRAWINGS

The accompanying figures, where like reference numerals refer to identical or functionally similar elements throughout the separate views, together with the detailed description below, are incorporated in, form part of the specification, and serve to further illustrate embodiments of concepts that include the claimed invention and explain various principles and advantages of those embodiments.

Skilled artisans will appreciate that elements in the figures, which form a part of this disclosure, are illustrated for simplicity and clarity and have not necessarily been drawn to scale. For example, the dimensions of some of the elements in the figures may be exaggerated relative to other elements to help improve understanding of embodiments of the present invention.

FIG. 1 illustrates a system for fabricating a high strength bonded film according to an embodiment of the invention.

FIG. 2 shows a cross-section of the concentric-multilayer polymer structure at line A-A in FIG. 1 during making of the high strength bonded film according to an embodiment of the invention.

FIG. 3 shows a cross-section of the film-web of the high strength bonded film according to an embodiment of the invention.

FIG. 4 shows a die for use in a system for making a high strength bonded film according to an embodiment of the invention.

FIG. 5 is a flow chart of a method of making the high strength bonded film according to an embodiment of the invention.

FIG. 6 shows a use of the invented high strength bonded film in trash bag application.

### DETAILED DESCRIPTION OF THE INVENTION

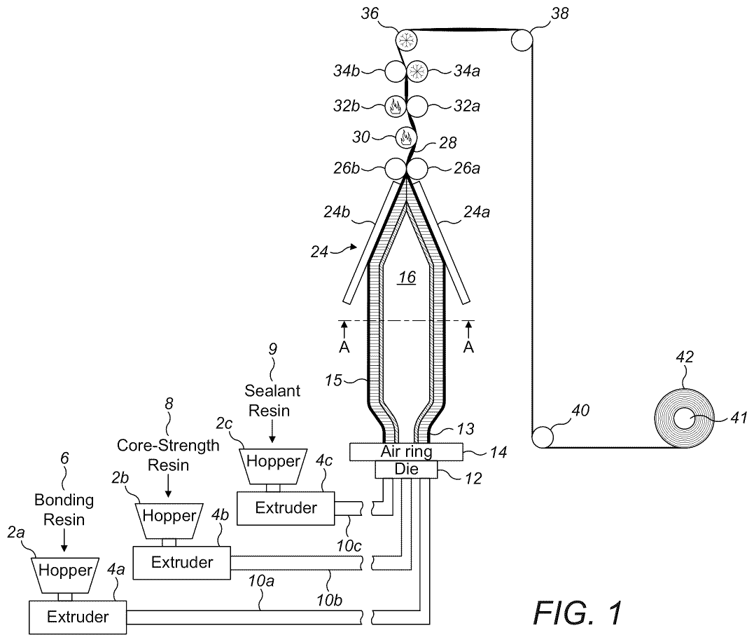

FIG. 1 shows a system for fabricating (making) a high strength bonded film according to an embodiment of the invention. The depicted system uses hoppers, extruders, a die, an air ring, a blower, a collapsing frame, and various rollers.

In the embodiment of FIG. 1, system 1 includes three hoppers, 2a, 2b, and 2c, for accepting three types of resin pellets. Hopper 2a is configured to accept pellets of a bonding resin 6, hopper 2b is configured to accept pellets of a core-strength resin 8, and hopper 2c is configured to accept pellets of a sealant resin 9. The resins could be polyethylene, polyethylene-based copolymers, or other types of polymer resins known in the art for making plastic films. Each hopper is coupled to its respective extruder.

As is known in the art, an extruder is configured to heat up and melt a resin material and propel it through a polymer-processing die, which in turn outputs a multilayer polymer structure having a desired cross-sectional profile. In FIG. 1, the hopper 2a is coupled to a bonding-resin extruder 4a, hopper 2b is coupled to a core-strength-resin extruder 4b, and hopper 4c is coupled to a sealant-extruder 4c. In the invented the system, the three separate extruders 4a. 4b, and 4c are operated in parallel, so as to perform coextrusion. Accordingly, as shown in FIG. 1, the three extruders are coupled via their respective feed pipes 10a, 10b, and 10c to a polymer-processing die 12 located downstream in the material-flow process.

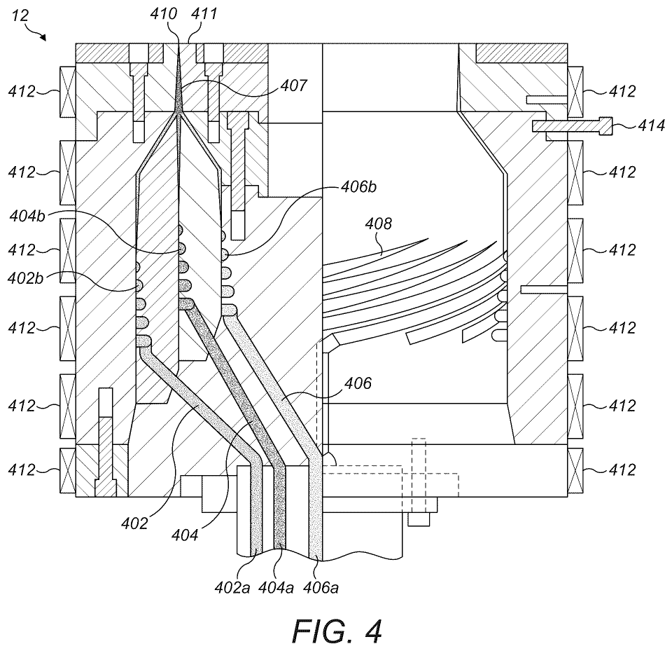

The die 12, which is illustrated in more detail in FIG. 4, is a metal restrictor that channels the streams of liquid polymers flowing through it and creates a particular cross-sectional profile at its output for each polymer stream. In the embodiment of the system in FIG. 1, at its output, the die 12 combines the three polymers flowing through it into a configuration of three concentric (ring-shaped) polymer layers, with the bonding layer on the inside, the core-strength layer in the middle, and the sealing layer on the outside. As a result, when viewed from a side, the molten concentric-multilayer annular polymeric structure 13 flowing out of the die 12 will have a tubular profile. In the preferred embodiment, the flow direction is straight up, toward a collapsing frame 24 and a pair of primary nip rollers, shown in FIG. 1 as rollers 26(a) and 26(b).

FIG. 4 depicts a cross-sectional view of the polymer-processing die 12 of FIG. 1. The die 12 includes three channels for polymer flow, an outer channel 402, a middle channel 404, and an inner channel 406. Each channel has a separate input port and a common output port. Specifically, channel 402 has an input port 402a, channel 404 has an input port 404a, and channel 406 has an input port 406a. As can be seen in FIG. 4, the three channels merge into a single, common path 407 that ends at an output port 410, at the die lip's surface 411. After entering a channel, molten polymer resin flows through the channel toward the common path 407 and exits at the die's output port 410. To prevent flowing molten polymer resin from solidifying within a channel and clogging it up, the die includes heaters 412 on the outside.

In the embodiment of the system in FIG. 1, channel 402 of the die 12 has a molten sealant resin flowing through it, channel 404 has a molten core-strength resin flowing through it, and channel 406 has a molten bonding resin flowing through it.

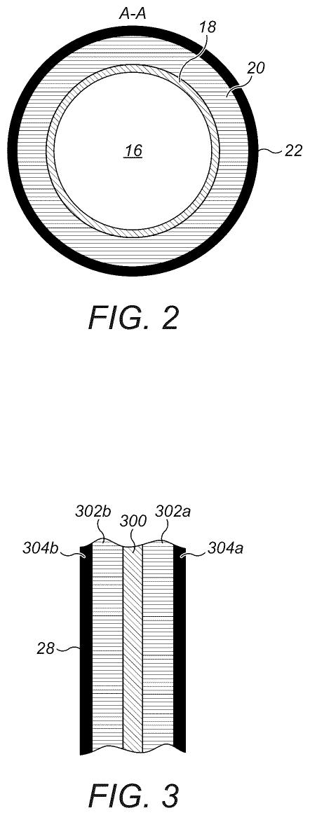

The shape of the output port (shape of the die's output opening) 410 determines geometry of the multi-laver polymer structure exiting the die 12. In the present invention, the cross-section of path 407 and the output port 410 are ring-shaped (annular), such that the die 12 outputs an annular multilayer polymer structure 13 (FIG. 1). Because the sealant resin flows through the outer channel 402, the core-strength resin flows through the middle channel 404, and the bonding resin flows through the inner channel 402, the multilayer polymer structure flowing out of the die 12 will be a concentric three-layer structure having the annular shape as illustrated in FIG. 2, with the bonding polymer layer 18 on the inside, the sealant polymer layer 22 on the outside, and the core-strength polymer layer 20 in the middle. Adjusting bolts 412 help to control the widths of the different channels, of path 407, and the size the output (exit) port 410, including the overall wall thickness of the outflowing concentric multilayer polymer structure 13.

To extend channel length, for each channel the die 1 includes a spiraling mandrel known in the art. In FIG. 4, the outer-mandrel is designated by reference 402b, the middle-mandrel is designated by reference 404b, and the inner-mandrel is designated by reference 406b. The inner-mandrel 406b is also depicted in a cut-away view by reference 408. (Cut-away views of the outer-mandrel 402b and the middle-mandrel 404b are not shown for clarity purposes.)

While not shown in FIG. 1, the system 1 also includes a blower that is used to blow a gaseous agent, such as cooled ambient air, into the center (inside the concentric rings) of the concentric-multilayer structure 13 flowing out of the die 12, causing the radius of the concentric-multilayer structure to expand. The expanded concentric-multilayer structure is identified in FIG. 1 by reference 15. When viewed from the side, along the flow direction, the three continuous polymer layers appear to form a bubble 16.

FIG. 2 shows a cross-section of the resulting bubble 16 at line A-A in FIG. 1. As illustrated in FIG. 2, the wall of the bubble 16 includes three separate polymer layers, the bonding-resin layer 18 of thickness Z, the core-strength-resin layer 20 of thickness Y, and the sealant-resin layer 22 of thickness X. As a result, the peripheral wall thickness of the bubble 16 is the sum of the thicknesses of the three individual polymer layers, i.e., X+Y+Z. Although percentages could differ, in one example, X could constitute about 10% of the peripheral wall thickness, Y could constitute about 80% of the peripheral wall thickness, and Z could constitute about 10% of the peripheral wall thickness.

The system in FIG. 1 also includes an air-ring element 14 located above the die 12. The air-ring 14 allows cooling air to be pumped along the outer periphery of the concentric-multilayer polymer structure 15 (on the outside of the bubble 16). This way, as the expanded concentric-multilayer structure 15 continues to flow up toward the collapsing frame 24 and nip rollers 26(a) and 26(b), while maintaining its form, the structure changes to a non-molten state. The temperature level at which this transition occurs is known as Vicat point.

The collapsing frame 24 (comprising a right and left guides 24a and 24b, respectively) and a primary nip-roller pair composed of rollers 26a and 26b are positioned downstream of the air ring 14. As the concentric-multilayer polymer structure 15 approaches the frame 24 and primary nip rollers 26a and 26b, it gets squeezed from two sides, forming a flat multilayer film-web 28. Importantly, bringing the two sides of the concentric bonding layer of thickness Z together (i.e., collapsing the bonding-layer inner ring of the concentric multilayer structure) creates a single bonding layer of thickness 2*Z. This is conceptually shown in FIG. 1 as collapsing of the bubble 16 and passing the collapsed bubble between the primary nip rollers 26a and 26b. The resulting multilayer film-web 28 has a single bonding layer of thickness 2*Z that is sandwiched between two core-strength layers of thickness Y each, with two sealant layers of thickness X each on the outside. A cross-section of the resulting film web 28 is illustrated in FIG. 3, with the single bond layer 300, two core-strengths layers 302a and 302b, and two sealant layers 304a and 304b. Thus, the total thickness of the resulting five-layer film-web 28 equals to 2*(X+Y+Z).

The resulting film-web 28 may be further processed by optional heating and cooling stages. The heating stage, during which the temperature of the film-web is kept below the Vicat temperature, enhances interlayer coupling. For example, in the five-layer film-web embodiment depicted in FIG. 3, heating helps each individual core-strength layer to molecularly couple (bond) to its respective sealant and bond layers.

The heating stage also helps to bond the two halves of the resulting bonding layer, which are brought together when the bubble 16 is collapsed, to molecularly couple (bond) to each other (referred as intralayer coupling).

The colling stage locks in the improved bonds.

In embodiment of FIG. 1, the heating stage includes a heading roller 30 followed by a pair of nip-rollers 32a and 32b, while the cooling stage includes a pair of nip-rollers 34a and 34b that are followed by a heading roller 36. As can be seen from FIG. 1, the heading roller 28 and the nip roller 32b heat the film-web during the heating stage, while the nip roller 34a and the heading roller 36 cool the film-web during the cooling stage. In other embodiments, the heating and cooling stages may be implemented by different combinations of rollers and by other means known in the art.

Thereafter, one or more idler rollers, represented in FIG. 1 by rollers 38 and 40, may be positioned downstream to direct the film-web 28 to a spool-roller 41, for winding the multilayer film-web into a film-roll 42.

In one embodiment, the pair of nip-rollers 32a and 32b and the pair of nip-roller rollers 34a and 34b rotate at the same speed as the pair of primary nip-rollers 26a and 26b.

In another embodiment of the invention, the multi-layer film-web 28 may be stretched, which further improves molecular alignment in the different layers, including the core-strength layer, thus further enhancing the tensile strength of the resulting multilayer firm. The stretching may be performed during the heating stage (heat-stretching), during the cooling stage (cool-stretching), or during both heating and cooling stages. As understood by a person of ordinary skill in the art, while substantially maintaining the respective ratios of thicknesses between the different layers, stretching of the multi-layer film-web will slightly reduce the overall thickness of the film-web.

For example, to perform heat-stretching using the system of FIG. 1, the pair of nip rollers 32a and 32b may stretch the film-web by rotating at a slightly higher speed (e.g., 1 to 10%) than the rotating speed of the pair of primary nip-rollers 26a and 26b.

In one embodiment of the invention, the cooling nip-roll pair of rollers 34a and 34b rotates at the same speed as the heating nip-roll pair of rollers 32a and 32b, in which case, stretching is accomplished during heat-stretching only.

To stretch the multi-layer film further, during cool-stretching, the pair of nip-rollers 34a and 34b may rotate at a slightly higher speed (e.g., about 1 to 15%) than the rotating speed of the nip-rollers 32a and 32b.

If the film-web is stretched during the cooling stage only, or if there is no heating-stage rollers, then the pair of nip-roller 34a and 34b may stretch the multi-layer film by rotating at a slightly higher speed (e.g., about 1 to 15%) than the rotating speed of the primary nip-rollers 26a and 26b.

Either way, the cooling stage locks in both the bonds and the overall stretch of the film-web 28.

When the film-web 28 is either heat-stretched or cool-stretched, it is then given time to contract (relax). In FIG. 1, the relaxation phase is provided by idler rollers 38 and 40, which are located downstream of the optional heating and cooling stages. As a result, the idler rollers 38 and 40 not only serve to direct the film-web toward the spool-roller 41, but they may also serve to allow contracting (relaxing) of the film-web in cases of the film-web having been stretched upstream.

The multilayer film of the present invention has an improved tensile strength for a given film thickness. The increased tensile strength of the invented multilayer film lies in the enhanced alignment of the resin molecules in the individual, thin core-strength layers of the film that are joined using a bonding layer. Thus, instead of outputting the core-strength resin as a single layer of thickness 2*Y, the die of the invented system outputs the core-strength resin in a shape of a ring having wall a thickness Y, which means that the die's core-strength-channel (FIG. 4, reference 404) output opening has width (thickness) Y. This essentially doubles the draw-down ratio, from S₁/(2*Y) to S₁/Y, greatly enhancing tensile strength of the produced film-web 28.

While, in the embodiment of the system depicted in FIG. 1, the resulting multilayered film-web includes five layers, the invention applies to any multilayer film-web embodiment having an odd number of layers, i.e., 3, 5, 7, etc. In any such multilayer film-web embodiment, the inner layer will be a single bonding layer of thickness 2*Z, where the two halves of the bonding layer were brought together by collapsing (flattening) a concentric multilayer-polymer structure initially generated by the die 12. For example, as long as the resulting film includes two thin core-strength layers as described above, even without the two sealant layers, the film will have an enhanced tensile strength.

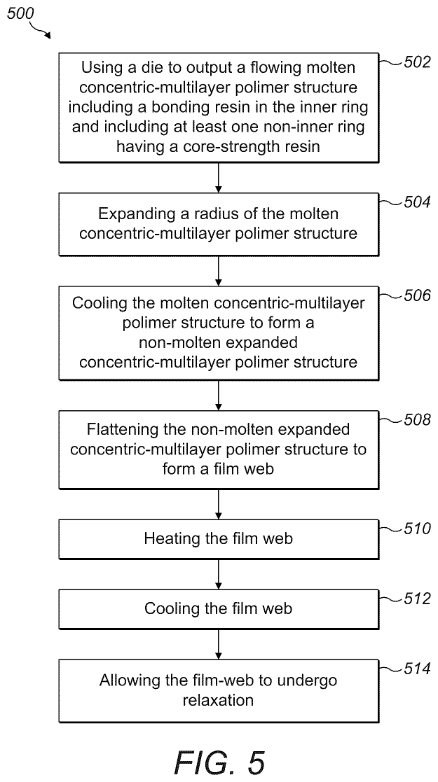

FIG. 5 is a flow chart of a method of making the high strength bonded film according to an embodiment of the invention. The method 500 starts at step 502, during which a die is used to output a flowing molten concentric-multilayer polymer structure that includes a bonding resin in the inner ring and at least one non-inner ring having a core-strength resin.

Next, in step 504, the radius of the flowing molten concentric-multilayer polymer structure is expanded to a desired dimension. This is usually accomplished by applying gaseous pressure against the inner surface of the molten concentric-multilayer polymer structure.

Next, in step 506, the concentric-multilayer polymer structure is cooled to solidify it, i.e., to form a non-molten concentric-multilayer polymer structure. This is usually accomplished by an air-ring that blows cooling air along the outer periphery (outer surface) of the flowing concentric-multilayer polymer structure.

Next, in step 508, the non-molten expanded concentric-multilayer polymer structure is flattened into a multilayer film-web. The flattening is generally performed using a collapsing frame and a pair of primary nip rollers.

Next, in step 510, the multi-layer film-web undergoes heating, which helps to improve interlayer and intralayer bonding.

After the heating step, in step 512, the multi-layer film-web undergoes cooling, which helps to lock in the bonding.

Optionally, during either the heating step 510, the colling step 512, or during both steps, the multilayer film-web may be stretched to further improve alignment of polymer molecules in the different layers of the film-web.

In such a scenario, in step 514, the film-web is allowed to undergo relaxation (contacting).

The present invention enables manufacture of a multilayered film with an improved tensile strength. The mechanisms leading to the improved tensile strength are:
(i) enhanced molecular alignment (orientation) associated with larger draw-down ratio of extruding and bonding two thinner core-strength layers, as compared to extruding a single thicker core-strength layer; and
(ii) stretching the film for an additional molecular alignment.

The present invention provides several benefits. For example, for tensile strength comparable to heavier (higher) gauge films, the invention allows using a lower gauge film, which in turn reduces the amount of resin material used, lowering manufacturing costs. Another benefit, the invention allows making a film having a significantly enhanced tensile strength at the same gauge value compared to conventional films.

For example, a 1″ wide piece of conventional 2.5 mil film having the strength layer sandwiched between two sealant layers, where the strength layer constitutes 80% of the total film thickness and each sealant layer constitutes 10% of the total film thickness, can break at a tensile break force of approximately 15 lbs. In contrast, even without hot-stretching or cold-stretching, a 1″ wide piece of 2.5 mil of five-layer film according to the present invention, in which the single combined bonding layer of thickness 2*Z is about 10% of the total film-web thickness, each core-strength layer of thickness Y is about 40% of the total film-web thickness, and each sealant layer Z is about 5% of the total film-web thickness, can reach a tensile break force of approximately 21 lbs, which constitutes almost 50% improvement in tensile strength.

Trash bags constitute one type of products that can use the invented multilayer film. For example, by keeping the film thickness the same, a trash bag can be made much stronger. Alternatively, keeping the tensile strength of the trash bag the same, one can use thinner (downgauge) film, thus reducing the amount of material needed to make the trash bag, which in turn can reduce manufacturing costs.

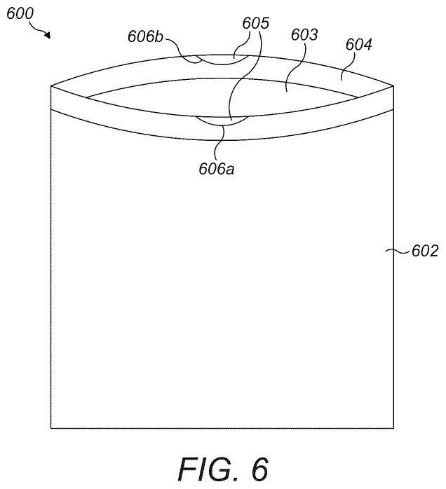

FIG. 6 shows a trash bag 600 made using the multilayer film of the present invention. The bag includes a body 602 having an opening 603 at one end. A hem 604 runs along the edge of the opening 603 and includes a drawstring 605 inside. The hem 604 has two small cutouts 606a and 606b that provide access to the drawstring 605, which allows a person to grasp and pull the drawstring while using the trash bag.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

While the foregoing descriptions may disclose specific values, unless expressly stated otherwise, other specific values may be used to achieve similar results. Further, the various features of the foregoing embodiments may be selected and combined to produce numerous variations of improved systems.

Moreover, in this document, relational terms such as first and second, up and down, and the like may be used solely to distinguish one entity or action from another entity or action without necessarily requiring or implying any actual relationship or order between such entities or actions. The terms “comprise(s)”, “comprising”, “has”, “having”, “includes”, “including”, “contains”, “containing” or any other variation thereof, are intended to cover a non-exclusive inclusion, so that a process, method, article, or apparatus that comprises, has, includes or contains a list of elements does not include only those elements but may include other elements not expressly listed or inherent to such process, method, article, or apparatus. An element preceded by “comprises . . . a”, “has . . . a”, “includes . . . a” or “contains . . . a” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially”. “essentially”. “approximately”, “about” or any other version thereof, are defined as being close to as understood by one of ordinary skill in the art. The term “coupled” as used herein is defined as connected, although not necessarily directly. A device or structure that is “configured” in a certain way is configured in at least that way but may also be configured in ways that are not listed.

In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I claim:

1. A multilayer film comprising:
a film-web having an odd number of layers that includes a bonding layer located between two strength layers,
wherein the film-web is formed from a concentric-multilayer polymer structure in which an inner layer of the concentric-multilayer polymer structure includes a bonding material.

2. The multilayer film of claim 1, wherein, for the bonding layer of thickness 2*Z and the two strength layers of thickness Y each, the film-web has a tensile strength at yield that is at least 20% greater than of a film-web that (i) lacks the bonding layer and (ii) includes a single strength layer of thickness 2*(Y+Z).

3. The multilayer film of claim 1, wherein the film-web is configured to undergo a hot-stretch process.

4. The multilayer film of claim 3, wherein, during the hot-stretch process, the film-web is configured to stretch by at least 1%.

5. The multilayer film of claim 1, wherein the film-web is configured to undergo a cold-stretch process.

6. The multilayer film of claim 5, wherein, during the cold-stretch process, the film-web is configured to stretch by at least 1%.

7. The multilayer film of claim 1,
wherein the film-web further comprises two sealant layers, and
wherein the two strength layers are located between the two sealant layers.

8. A multilayer film comprising:
a film-web having an odd number of resin layers that includes a bonding layer that is located between the two strength layers,
wherein the film-web is formed from a set of concentric polymer layers having a tubular profile in which an inner polymer layer includes a bonding material.

9. The multilayer film of claim 8, wherein, for the bonding layer of thickness 2*Z and the two strength layers of thickness Y each, the film-web has a tensile strength at yield that is at least 20% greater than of a film-web that (i) lacks the bonding layer and (ii) includes a single strength layer of thickness 2*(Y+Z).

10. The multilayer film of claim 8, wherein the film-web is configured to undergo a hot-stretch process.

11. The multilayer film of claim 10, wherein, during the hot-stretch process, the film-web is configured to stretch by at least 1%.

12. The multilayer film of claim 8, wherein the film-web is configured to undergo a cold-stretch process.

13. The multilayer film of claim 12, wherein, during the cold-stretch process, the film-web is configured to stretch by at least 1%.

14. The multilayer film of claim 8,
wherein the film-web further comprises two sealant layers, and
wherein the two strength layers are located between the two sealant layers.

15. A method of producing a multilayer film comprising the steps of:
using a die to output a flowing molten concentric-multilayer polymer structure in which an inner layer of the concentric-multilayer polymer structure includes a bonding resin and at least one non-inner layer of the concentric-multilayer polymer structure includes a strengthening resin;
expanding a radius of the molten concentric-multilayer polymer structure;
air-cooling the concentric-multilayer polymer structure to form a non-molten expanded concentric-multilayer polymer structure; and
flattening the non-molten expanded concentric multilayer polymer structure to form a film-web having an odd number of layers that includes a bonding layer located between two strength layers.

16. The method of claim 15, wherein the flattening step comprises using a collapsing frame.

17. The method of claim 16, wherein the flattening step comprises using a pair of nip rollers.

18. The method of claim 15, further comprising hot-stretching the film-web.

19. The method of claim 16, further comprising cold-stretching the film-web following the hot-stretching step.

20. The method of claim 15, further comprising the step of allowing the film-web to undergo a relaxation process.
